(19) United States
(12) Patent Application Publication
(10) Pub. No.: US 2026/0329074 A1
(43) Pub. Date: Oct. 22, 2026

(54) CAMERA MODULE AND LENS CLEANING METHOD USING THE SAME

(71) Applicant: SAMSUNG ELECTRO-MECHANICS CO., LTD., Suwon-si (KR)

(72) Inventors: Jung Hyun PARK, Suwon-si (KR); Dooseub SHIN, Suwon-si (KR); Namkeun OH, Suwon-si (KR); Hyuntaek HONG, Suwon-si (KR); Sanghyun JI, Suwon-si (KR)

(73) Assignee: SAMSUNG ELECTRO-MECHANICS CO., LTD., Suwon-si (KR)

(21) Appl. No.: 19/541,797

(22) Filed: Feb. 17, 2026

(30) Foreign Application Priority Data
Apr. 18, 2025 (KR) 10-2025-0051043
Aug. 13, 2025 (KR) 10-2025-0112295

(51) Int. Cl. G02B 27/00; B05B 1/14; B60S 1/48; B60S 1/50; B60S 1/52; B60S 1/56

(52) U.S. Cl. CPC G02B 27/0006; B05B 1/14; B60S 1/487; B60S 1/50; B60S 1/52; B60S 1/56

(57) ABSTRACT

A camera module includes a lens barrel accommodating a lens; a lens cap, disposed on a top surface of the lens barrel, configured to press-fit and fix the lens; and a lens cleaning unit integrally formed with the lens cap and configured to inject fluid to a surface of the lens. The lens cleaning unit includes a nozzle opening disposed at a top end of the lens cap and configured to inject fluid toward the surface of the lens, a fluid inlet disposed at a bottom end of the lens cap and configured to receive external fluid, and a fluid passage disposed inside the lens cap and configured to fluidly communicate the fluid inlet with the nozzle opening.

### CROSS-REFERENCE TO RELATED APPLICATIONS

This application claims the benefit under 35 USC 119(a) of Korean Patent Application Nos. 10-2025-0051043 filed on Apr. 18, 2025, and 10-2025-0112295 filed on Aug. 13, 2025, in the Korean Intellectual Property Office, the entire disclosures of which are incorporated herein by reference for all purposes.

### BACKGROUND

### 1. Field

The present disclosure relates to a camera module and lens cleaning method using the same.

### 2. Description of the Background

With the recent advancements in autonomous driving technology, vehicles are increasingly relying on multiple cameras to accurately perceive their surroundings. Cameras act as vehicle's eyes, collecting and analyzing vast amounts of visual data in real time, including lanes, traffic lights, pedestrians, and obstacles, to provide the basis for decision-making for autonomous driving systems.

Therefore, to ensure the stability and reliability of autonomous driving systems, it may be desirable to obtain clear, distortion-free camera images. However, cameras exposed to the exterior of a vehicle are susceptible to contamination on their lens surfaces by various external contaminants, such as rain, snow, dust, mud, and insect marks. Contaminated lenses distort or block light reaching the image sensor, resulting in blurred or noisy images. This can lead to serious image recognition errors and potentially malfunctions in autonomous driving systems.

To address this issue, various cleaning technologies are being developed to automatically remove foreign matter from the camera lens surface. Typical technologies include physical cleaning using wipers and nozzle injecting, which injects a cleaning solution. Of these, nozzle injecting is widely used due to its relatively simple mechanical driving system, which facilitates miniaturization and high durability.

However, conventional nozzle injecting methods, which are comprised of separate components from the camera module, increase the system's volume and, due to their greater distance from the lens surface, weaken cleaning power. Furthermore, in low temperature winter environments, condensation can form on the nozzle or internal fluid passage, potentially clogging the nozzle.

Therefore, there is a growing demand for camera lens cleaning technologies that achieve miniaturization and integration by reducing the number of components, while maximizing cleaning efficiency through close-range spraying and ensuring stable performance even in winter.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel accommodating a lens; a lens cap, disposed on a top surface of the lens barrel, configured to press-fit and fix the lens; and a lens cleaning unit integrally formed with the lens cap and configured to inject fluid to a surface of the lens. The lens cleaning unit includes a nozzle opening disposed at a top end of the lens cap and configured to inject fluid toward the surface of the lens, a fluid inlet disposed at a bottom end of the lens cap and configured to receive external fluid, and a fluid passage disposed inside the lens cap and configured to fluidly communicate the fluid inlet with the nozzle opening.

The nozzle opening may include a plurality of nozzle openings disposed at predetermined intervals along a circumference of the lens.

At least one of the plurality of nozzle openings may be configured to inject liquid, and at least another one of the plurality of nozzle openings is configured to inject gas.

At least one of the plurality of nozzle openings may be configured to inject cleaning fluid, and at least another one of the plurality of nozzle openings may be configured to intake the injected cleaning fluid.

Each of a plurality of fluid passages connected to the plurality of nozzle openings may have a different diameter.

The nozzle opening may be continuously disposed along the circumference of the lens.

The nozzle opening may include a lower surface portion having a same contour as a contour of the surface of the lens, and an upper surface portion disposed to have a predetermined angle with respect to the lower surface portion.

The upper surface portion may include a reflective surface that is configured to change an injection direction of the fluid in the fluid passage to the surface of the lens.

The lens cap may include an inner cap disposed at the top surface of the lens barrel to press-fit and fix the lens, and an outer cap coupled along an outer circumferential surface of the inner cap and having the nozzle opening, the fluid passage, and the fluid inlet.

The outer cap may include a first groove on an inner surface thereof so that a portion of the fluid passage is formed by coupling with the inner cap.

The nozzle opening may be disposed in plurality at predetermined intervals, and may further include a plurality of nozzle openings and at least one flow rate control unit configured to generate a difference in flow rate of the fluid injected through the plurality of nozzle openings to implement a sequential injection.

The flow rate control unit may include either one or both of a diameter changing part in which a diameter of at least a section of the fluid passage is different from a diameter of other sections of the fluid passage, and a reservoir disposed at the fluid passage and configured to temporarily store fluid.

The lens cap may include a main cap coupled to the lens barrel, and a channel member coupled to a portion of an outer surface of the main cap and in which the nozzle opening, the fluid passage, and the fluid inlet are disposed.

The channel member may include a second groove on an inner surface thereof so that a portion of the fluid passage is formed by coupling with the main cap.

Either one or both of an outer surface and an inner surface of the lens cap may further include a heating member disposed at a portion corresponding to the fluid passage.

The camera module may be mounted on an exterior panel of vehicle, and an elastic sealing member may be further disposed between the top end of the lens cap and the exterior panel to prevent fluid injected from the lens cleaning unit from flowing into the vehicle.

In another general aspect, a lens cleaning unit include a nozzle opening integrally formed on a top end of a lens cap configured to press-fit and fix a lens disposed at a top surface of a lens barrel accommodating the lens, wherein the nozzle opening is configured to inject fluid toward a surface of the lens; a fluid inlet disposed at a bottom end of the lens cap and configured to receive external fluid; and a fluid passage disposed inside the lens cap and configured to fluidly communicate the fluid inlet with the nozzle opening.

A lens cleaning method using the lens cleaning unit above includes supplying fluid from an external fluid source to the fluid passage, and injecting the fluid toward the surface of the lens through the nozzle opening.

The injecting of the fluid may include sequentially injecting the fluid by varying a flow rate through a plurality of nozzle openings of the nozzle opening formed at the lens cap.

The injecting of the fluid may include injecting liquid through at least one of a plurality of nozzle openings of the nozzle opening and injecting gas through at least another one of the plurality of nozzle openings.

Other features and aspects will be apparent from the following detailed description, the drawings, and the claims.

### BRIEF DESCRIPTION OF DRAWINGS

FIG. 1 is a perspective view schematically illustrating a camera module according to one embodiment.

FIG. 2 is an exploded perspective view of the camera module of FIG. 1.

FIG. 3 is a cross-sectional view of the camera module of FIG. 1.

FIG. 4A and FIG. 4B are drawings illustrating embodiments of a nozzle opening.

FIG. 5A and FIG. 5B are drawings illustrating another embodiments of a nozzle opening.

FIG. 6A and FIG. 6B are drawings illustrating another embodiments of a nozzle opening.

FIG. 7A to FIG. 7D are drawings illustrating the operating state of a lens cleaning unit according to an embodiment.

FIG. 8 is a drawing illustrating a state in which a camera module including a lens cleaning unit according to an embodiment is mounted on a vehicle.

FIG. 9 is a perspective view schematically illustrating a camera module according to another embodiment.

FIG. 10 is a cross-sectional view of the camera module of FIG

FIG. 11 is a perspective view schematically illustrating a camera module according to another embodiment.

FIG. 12 is an exploded perspective view of the camera module of FIG. 11.

FIG. 13 is a cross-sectional view of the camera module of FIG. 11.

FIG. 14 is a drawing illustrating an outer cap of the camera module of FIG. 11.

FIG. 15 is a perspective view schematically illustrating a camera module according to another embodiment.

FIG. 16 is a cross-sectional view of the camera module of FIG. 15.

FIG. 17 is a perspective view schematically illustrating a camera module according to another embodiment.

FIG. 18 is a cross-sectional view of the camera module of FIG. 17.

FIG. 19 is a cross-sectional view illustrating a modified example of a heating element in the camera module of FIG. 17.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

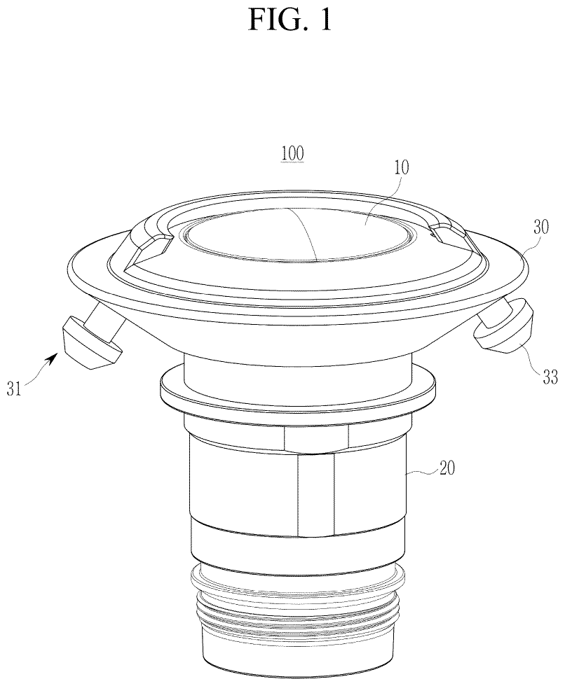

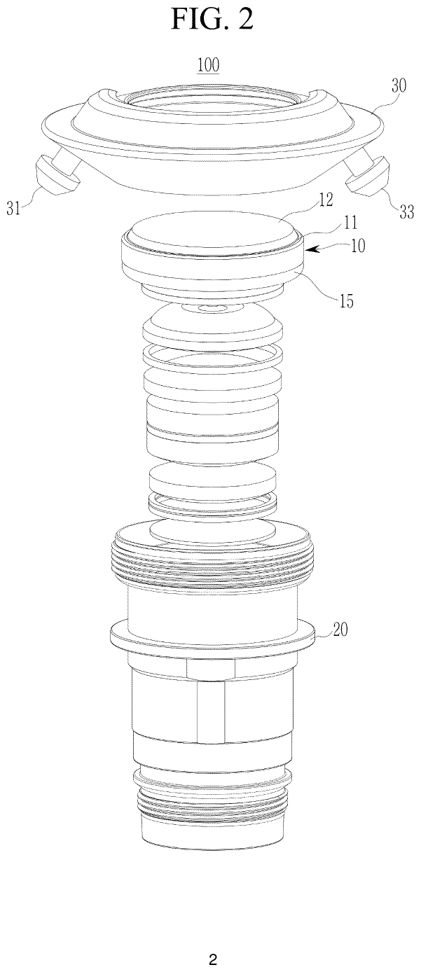

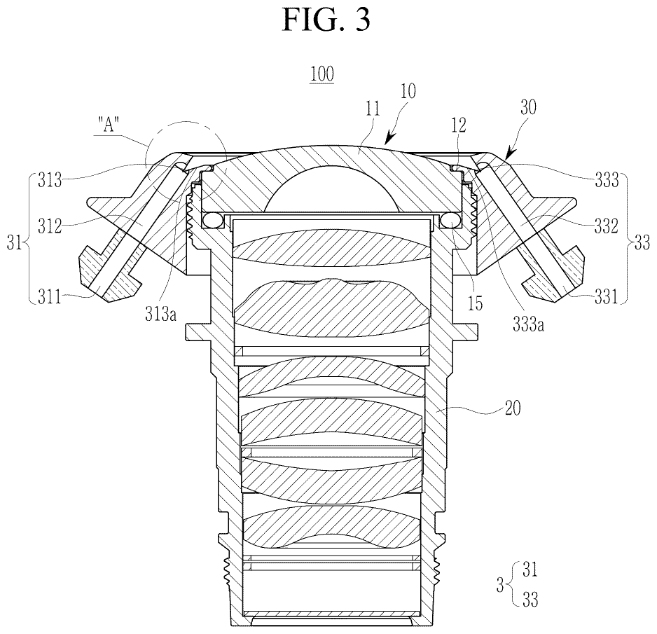

FIG. 1 is an external perspective view schematically illustrating a camera module including a lens cleaning unit according to an embodiment, FIG. 2 is an exploded perspective view of the camera module of FIG. 1, and FIG. 3 is a cross-sectional view of the camera module of FIG. 1.

Referring to FIG. 1 to FIG. 3, a camera module 100 according to an embodiment may include a lens array 10, a lens barrel 20, and a lens cleaning unit 3. In the present embodiment, the lens cleaning unit 3 may be provided in the form of a lens cap 30 to simultaneously perform a function of fixing the lens array 10 and a function of cleaning a surface of the lens array 10.

The lens array 10 may include one or more lenses having optical characteristics such as refractive indices that are the same or different from each other, and for convenience of description, the lens located at the top is designated as a lens 11. Hereinafter, only the lens 11 disposed at the top is illustrated in following drawings.

The lens array 10 may be mounted on the lens barrel 20 along the optical axis. In this case, a position of the lens array 10 may be fixed by a lens spacer 15. Here, the optical axis may be set as the central axis of the lens accommodated in the lens barrel 20, and the optical axis direction may mean a direction parallel to this central axis. The lens array 10 may have a desired number of lenses arranged according to the design of the lens barrel 20.

The lens barrel 20 may have a hollow cylindrical shape so that the lens array 10 can be accommodated therein, and an image sensor (not shown) may be disposed under the lens barrel 20 in the optical axis direction to convert light incident through the lens barrel 20 into an electrical signal, which can be transmitted to an electronic device through a circuit board (not shown).

The lens cleaning unit 3 may be a configuration that injects a fluid onto a surface of the uppermost lens 11 of the lens array 10, and may be integrally formed with the lens cap 30. The lens cap 30 may be disposed at the top of the lens barrel 20 and serves to press-fit or fix the lens array 10.

In the lens cleaning unit 3, a plurality of fluid injection parts may be integrally formed with the lens cap 30. Although the present embodiment is shown and described as including two fluid injection parts, the present disclosure is not limited thereto and may be included as many as desired according to design. In addition, the lens cleaning unit 3 may include not only a fluid injection part, but also a fluid intake part that intakes the fluid injected from the fluid injection part.

The lens cleaning unit 3 may include a first fluid injection part 31 and a second fluid injection part 33. The lens cleaning unit 3 may include fluid inlets 311 and 331 receiving a fluid from the outside, fluid passages 312 and 332 formed inside the lens cap 30, and nozzle openings 313 and 333 injecting the fluid toward the surface of the uppermost lens 11 of the lens array 10.

That is, the first fluid injection part 31 may include the first fluid inlet 311, the first fluid passage 312, and the first nozzle opening 313, and the second fluid injection part 33 may include the second fluid inlet 331, the second fluid passage 332, and the second nozzle opening 333. In the present embodiment, although the first and second fluid injection parts 31 and 33 are illustrated and described as having fluid inlets 311 and 331 respectively, the present disclosure is not limited thereto, and one fluid inlet may be shared by a plurality of the fluid injection parts, and the fluid may be transferred to each nozzle opening by the fluid passage.

The first and second fluid inlets 311 and 331 may be formed at the bottom of the lens cap 30 and may receive a cleaning fluid from an external fluid source through a supply line. The cleaning fluid may be supplied in a liquid or gaseous state, for example, a cleaning solution may be supplied to the first fluid inlet 311 and a compressed air may be supplied to the second fluid inlet 331.

The first and second fluid passages 312 and 332 may be configured to connect the fluid inlet and the nozzle opening, and are built inside the lens cap 30 and serve as a passage through which a cleaning fluid supplied through the fluid inlet moves. Accordingly, the first and second fluid passages 312 and 332 may have a tunnel or channel shape.

Meanwhile, when the first and second fluid injection parts 31 and 33 share one fluid inlet, the first and second fluid passages 312 and 332 may have a structure branched from the inside of the lens cap 30.

The first and second fluid passages 312 and 332 may have the same diameter from the fluid inlet to the nozzle opening, or may have a diameter larger or smaller in some sections than other sections to control the flow rate of a fluid reaching the nozzle opening. For example, by forming the diameter of the first fluid passage 312 larger than the diameter of the second fluid passage 332, the speed of the fluid injected through the first nozzle opening 313 can be made smaller than the speed of the fluid injected through the second nozzle opening 333.

The first and second fluid passages 312 and 332 may have circular, rectangular, or other shapes optimized for fluid flow in cross-section. The corners can be designed to be rounded or streamlined to minimize the occurrence of vortex or turbulence within the fluid passage, thereby reducing pressure loss and enabling stable fluid transport. In addition, the first and second fluid passages may have a tapered shape in which the cross-sectional area gradually narrows as they get closer to the nozzle opening, so the flow rate can be gradually increased to increase injection efficiency.

The first and second nozzle openings 313 and 333 may be configured to inject the cleaning fluid supplied through the fluid passage to the surface of the lens 11, and may be integrally formed at the top of the lens cap 30, and may be formed at predetermined intervals along the circumference of the lens 11. The interval between the first and second nozzle openings 313 and 333 may be set according to the injection angle of the injected fluid, and may be disposed at equal intervals or predetermined intervals according to the number of nozzle openings.

The first and second nozzle openings 313 and 333 may be formed to be disposed on the same surface as the surface of the lens 11. For this purpose, a mounting groove 12 may be formed on the outer edge of the lens 11, and lower surface portions 313a and 333a of the first and second nozzle openings 313 and 333 may be coupled to the mounting groove 12. The height of the lower surface portions 313a and 333a based on the optical axis decreases as it gets closer to the nozzle openings 313 and 333 in the mounting groove 12, and the lower surface portions 313a and 333a may be located at the same level as or lower than the mounting groove 12.

The fluid injected through the first and second nozzle openings 313 and 333 may be liquid or gas. For example, the first nozzle opening 313 may inject a cleaning solution as liquid, and the second nozzle opening 333 may inject compressed air as gas. Meanwhile, the present disclosure is not limited to this, and various changes can be made, such as additional nozzle openings for intaking an injected fluid, or the first nozzle opening 313 injecting a cleaning fluid and the second nozzle opening 333 intaking the injected fluid.

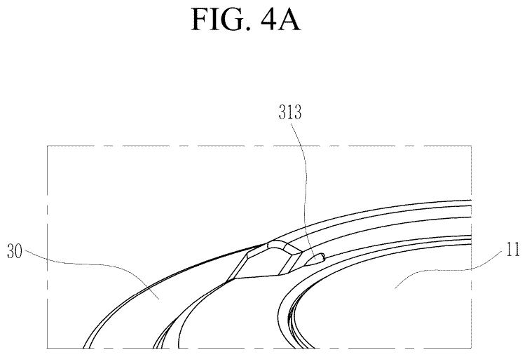

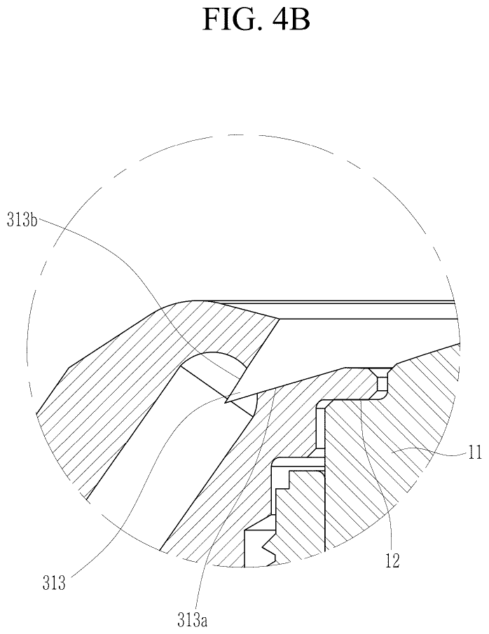

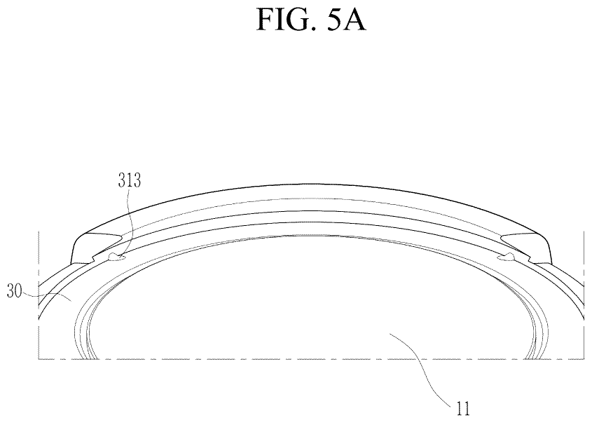

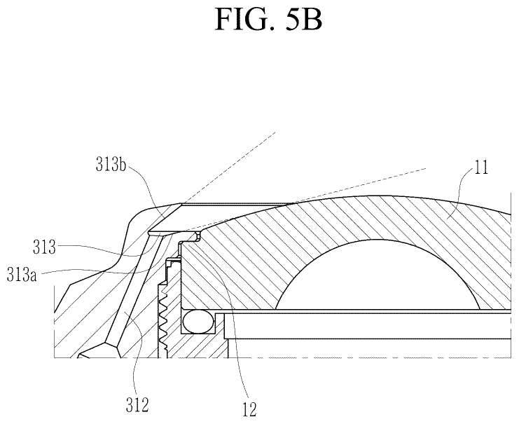

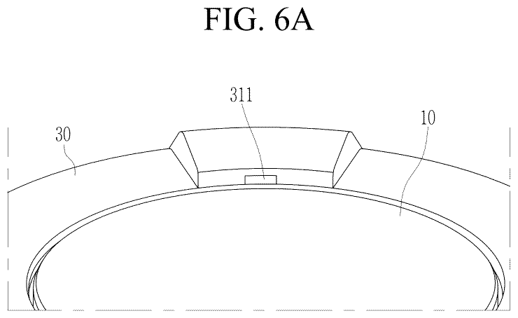

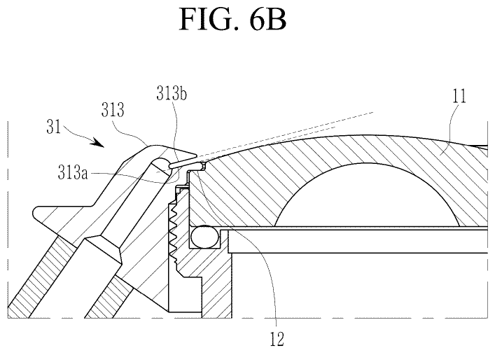

FIG. 4 to FIG. 6 illustrate various shapes of nozzle openings. Hereinafter, various embodiments of the nozzle opening will be described in detail with reference to these drawings. FIG. 4A and FIG. 4B are drawings illustrating embodiments of a nozzle opening, FIG. 5A and FIG. 5B are drawings illustrating another embodiments of a nozzle opening, and FIG. 6A and FIG. 6B are drawings illustrating another embodiments of a nozzle opening.

Referring to FIG. 4A and FIG. 4B, the nozzle opening 313 may have a vertical asymmetric structure to maximize injection efficiency. The nozzle opening 313 may have the lower surface portion 313a forming the same surface as the surface of the lens 11, and an upper surface portion 313b formed to be opened upward to have a predetermined angle with respect to the lower surface portion 313a.

The lower surface portion 313a may be formed to form an angle parallel to or small to the tangential direction of the surface of the lens 11 so that a fluid injected from the nozzle opening 313 may flow along the curved surface of the lens 11 by the Coanda effect. To this end, the lens 11 may have the mounting groove 12 in which the lower surface portion 313a is mounted on the rim thereof.

The upper surface portion 313b may be configured to determine the injection angle and injection force of an injected fluid, and may be formed to have an angle greater than the angle formed by the lower surface portion 313a with respect to a plane perpendicular to the optical axis direction. By adjusting the angle formed by the upper surface portion 313b with respect to the lower surface portion 313a, a wide injection angle capable of cleaning the entire lens in a transverse direction parallel to the lens surface may be implemented.

The upper surface portion 313b may be formed at an angle at which a fluid injected through the nozzle opening 313 is directly injected to the surface of the lens 11. Alternatively, the upper surface portion 313b may be formed at an angle at which the injected fluid collides with the upper surface portion 313b and changes in direction and shape so as to be reflected to the surface of the lens 11.

The nozzle opening 313 may have a groove of a specific shape depending on the type and purpose of a fluid, and for example, if the fluid is a liquid, it may have a ‘V’-shaped groove to concentrate the fluid for strong cleaning power.

Referring to FIG. 5A and FIG. 5B, the nozzle opening 313 may have the lower surface portion 313a forming the same surface as the surface of the lens 11, and the upper surface portion 313b formed to be opened upward to have a predetermined angle with respect to the lower surface portion 313a. In the present embodiment, the nozzle opening 313 may have a deflector nozzle structure. Therefore, the upper surface portion 313b may include a reflective surface in which a fluid supplied from the fluid passage 312 collides and converts the injection direction to the surface of the lens 11.

In the present embodiment, in order to efficiently change the injection direction of a fluid supplied from the fluid passage 312, an angle formed by the upper surface portion 313b with respect to the lower surface portion 313a may be smaller than an angle formed by the upper surface portion with respect to the lower surface portion in the direct injection type nozzle opening.

Referring to FIG. 6A and FIG. 6B, the nozzle opening 313 may have a structure in which the lower surface portion 313a and the upper surface portion 313b are substantially parallel to each other. The lower surface portion 313a may form the same surface as the surface of the lens 11, and the upper surface portion 313b may be formed substantially parallel to the lower surface portion 313a at a predetermined interval.

The nozzle opening 313 according to the present embodiment has a structure suitable when a fluid is a gas, and may have a ‘straight groove’ or a slit-shaped groove for uniform diffusion of a gas.

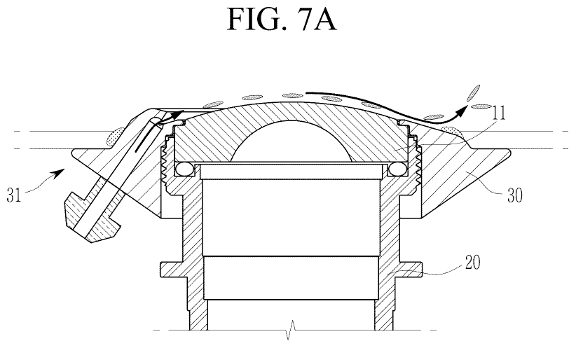

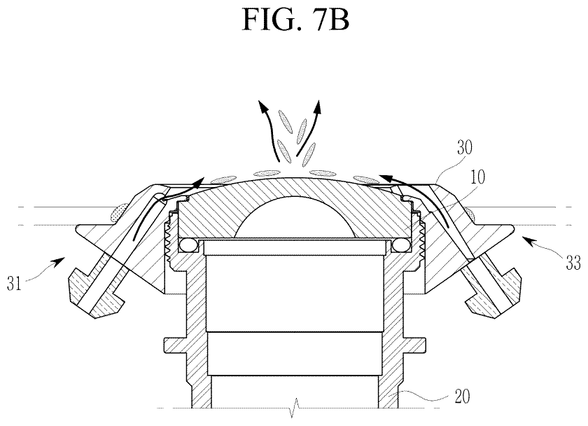

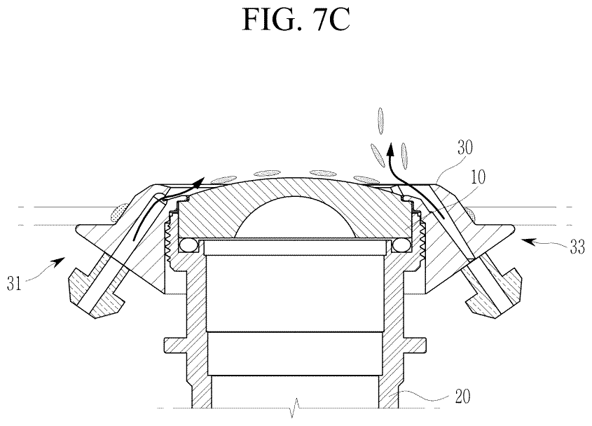

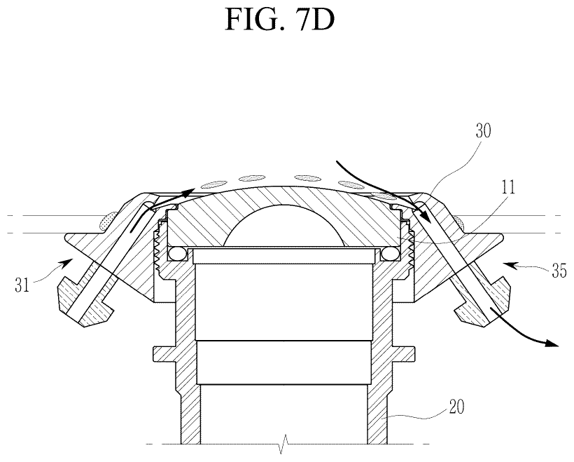

FIG. 7A to FIG. 7D are drawings illustrating the operating state of a lens cleaning unit according to an embodiment.

Referring to FIG. 7A, the fluid injected through the first fluid injection part 31 may flow along the surface of the lens 11 by the Coanda effect and may be discharged to the outside after cleaning the surface of the lens 11.

Referring to FIG. 7B, a fluid may be simultaneously injected from the first fluid injection part 31 and the second fluid injection part 33 to clean the surface of the lens 11 and be discharged to the outside by colliding the surface at approximately the center of the lens 11.

Referring to FIG. 7D, a cleaning solution may be injected from the first fluid injection part 31 and a gas may be injected from the second fluid injection part 33 to form an air curtain in the vertical direction of the lens 11, thereby removing the residual liquid.

Referring to FIG. 7D, the lens cleaning unit may include the first fluid injection part 31 and a first fluid intake part 35. The fluid injected from the first fluid injection part 31 may be drained to the first fluid intake part 35 by bending by the Coanda effect after cleaning the surface of the lens 11.

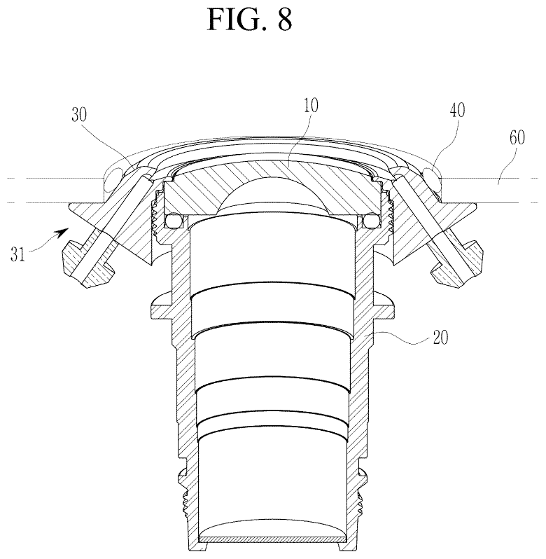

FIG. 8 is a drawing illustrating a state in which a camera module including a lens cleaning unit according to an embodiment is mounted on a vehicle.

Referring to FIG. 8, a camera module may be mounted on an exterior panel 60 of a vehicle. In this case, a sealing member 40 may be disposed between the top of the lens cap 30 and the exterior panel 60 to prevent fluid injected from the lens cleaning unit from flowing into the vehicle. The sealing member 40 may be made of an elastic material such as rubber or silicone, and may seal a gap between the lens cap 30 and the exterior panel 60 to prevent cleaning fluid from entering the vehicle, and may also block outside dust or moisture from entering the vehicle.

Hereinafter, a lens cleaning method using the camera module according to the present embodiment will be described in detail.

First, a fluid may be supplied from an external fluid source (not shown) to the lens cleaning unit formed inside the lens cap 30. The fluid may be supplied through a pipe (not shown) connecting the fluid source and the fluid inlets 311 and 331, and the fluid supplied through the fluid inlets 311 and 331 may be moved in the fluid passages 312 and 332. In this case, the same fluid may be supplied to the fluid inlets 311 and 331, a liquid may be supplied to the first fluid inlet 311, and a gas may be supplied to the second fluid inlet 331.

Next, the fluid moving through the fluid passages 312 and 332 may be infected toward the surface of the lens 11 through the nozzle openings 313 and 333. The Injection step may be controlled such that a flow rate of the fluid injected through each of the nozzle openings 313 and 333 has a difference. For example, the fluid can be controlled to be injected sequentially. This sequential injection control may be performed by forming different diameters of each of the fluid passages 312 and 332.

In the injection step, the same fluid may be injected through each of the nozzle openings 313 and 333, a cleaning solution may be discharged as liquid from the first nozzle opening 313, and compressed air may be discharged as gas from the second nozzle opening 333.

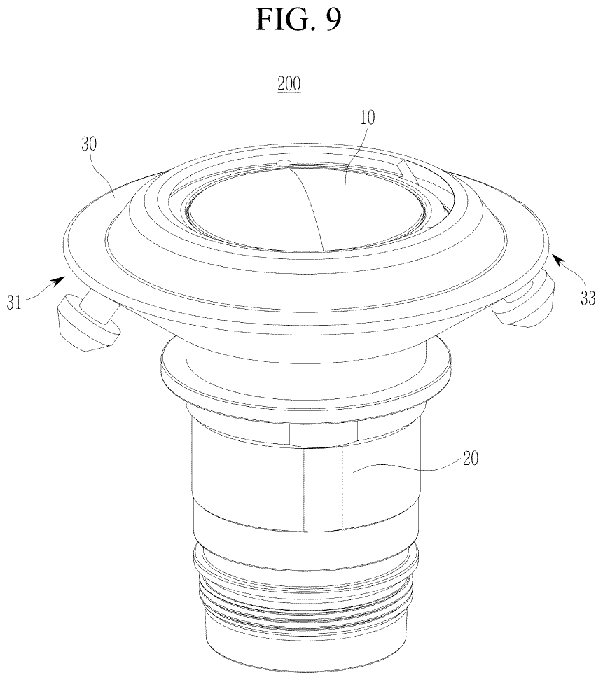

FIG. 9 to FIG. 19 are drawings illustrating a camera module according to various embodiments. Hereinafter, camera modules according to various embodiments will be described in detail with reference to FIG. 9 to FIG. 19.

The camera modules illustrated in FIG. 9 to FIG. 19 have substantially the same configuration as that of the embodiment described with reference to FIG. 1 to FIG. 8. Hereinafter, different configurations will be described, and the same configurations will be used by the same reference numerals, and configurations that are not separately described may be configured in the same manner as the embodiments shown in FIG. 1 to FIG. 8.

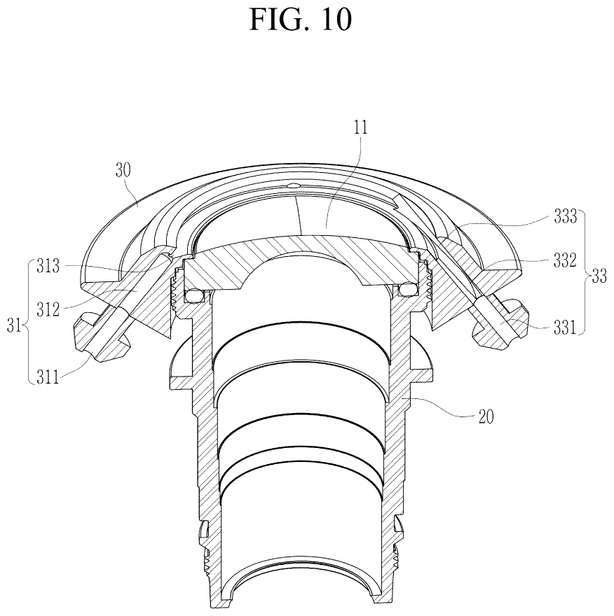

FIG. 9 is a perspective view schematically illustrating a camera module according to another embodiment, and FIG. 10 is a cross-sectional view of the camera module of FIG. 9.

Referring to FIG. 9 and FIG. 10, a camera module 200 according to the present embodiment may have a shape in which the nozzle opening of the lens cleaning unit is continuously formed along the circumference of the lens. In particular, the second nozzle opening 333 may have a slit structure in the form of a long groove continuously formed along the circumference of the lens 11.

This structure may be suitable for injecting a gas, and according to the present embodiment, the surface of the lens 11 can be cleaned by injecting a cleaning solution through the first nozzle opening 313, and a compressed air can be injected through the second nozzle opening 333 to form an air curtain on the surface of the lens 11 to discharge the remaining cleaning solution to the outside.

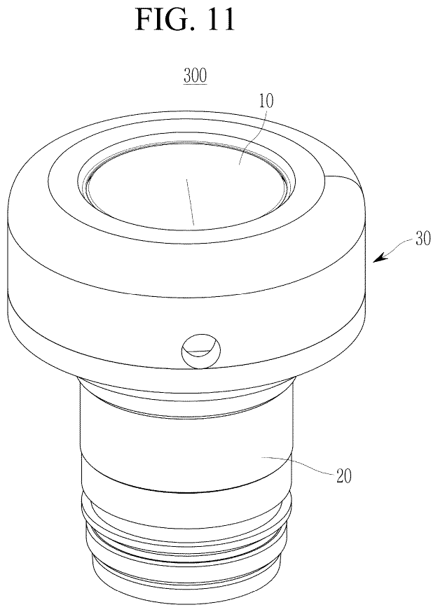

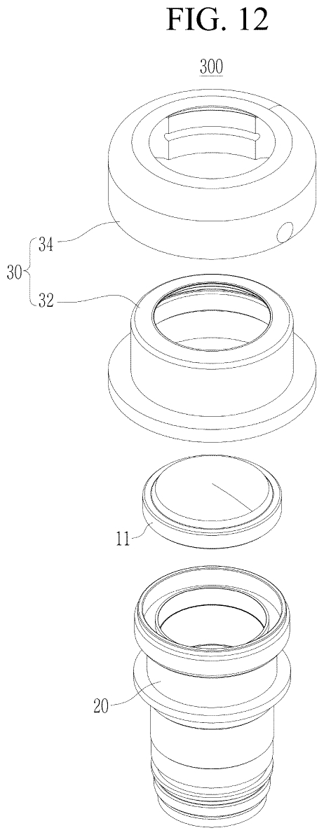

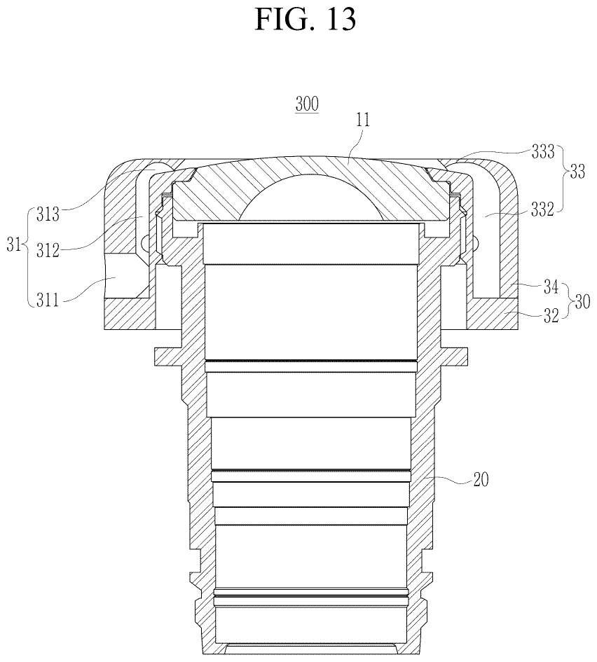

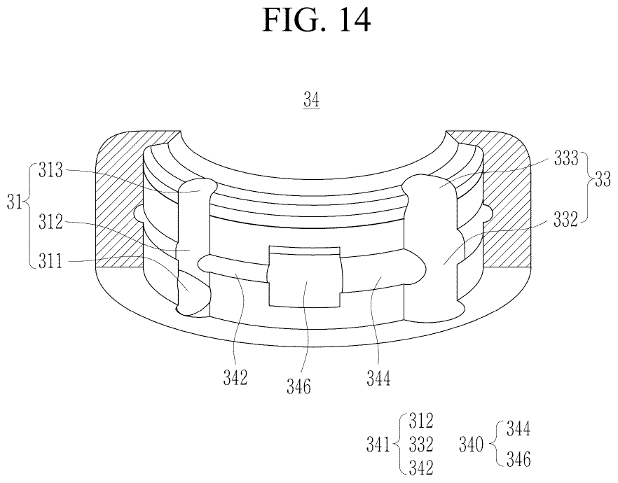

FIG. 11 is a perspective view schematically illustrating a camera module according to another embodiment, FIG. 12 is an exploded perspective view of the camera module of FIG. 11, FIG. 13 is a cross-sectional view of the camera module of FIG. 11, and FIG. 14 is a drawing illustrating an outer cap of the camera module of FIG. 11.

Referring to FIG. 11 to FIG. 14, a camera module 300 according to the present embodiment may be configured such that the lens cap 30 includes an inner cap 32 and an outer cap 34. The inner cap 32 may be disposed at the top of the lens barrel 20 to press-fit and fix the lens 11, and the outer cap 34 may serve as a lens cleaning unit by incorporating the fluid injection parts 31 and 33.

The inner cap 32 press-fit and fix the lens 11 into the lens barrel 20, and the upper surface of the inner cap 32 may be arranged to form the same surface as the surface of the lens 11.

The outer cap 34 may be coupled along the outer circumferential surface of the inner cap 32, and may have the first fluid injection part 31 and the second fluid injection part 33. The first fluid injection part 31 and the second fluid injection part 33 may each have the fluid inlet or may share one fluid inlet 311. In the present embodiment, an embodiment in which one fluid inlet 311 is shared will be described.

The fluid passages 312 and 332 may be formed inside the outer cap 34. The fluid passages 312 and 332 may be formed by being incorporated in the outer cap 34 in a tubular shape, or may be formed by combining the inner cap 32 and the outer cap 34. In the present embodiment, an embodiment in which the fluid passage is formed by combining the inner cap 32 and the outer cap 34 is described. Therefore, a first groove 341 constituting a part of the fluid passage may be formed on the inner surface of the outer cap 34, and the first groove 341 may be sealed by the combination of the inner cap 32 and the outer cap 34, so that the fluid passage consisting of the outer surface of the inner cap 32 and the first groove 341 may be formed.

The first fluid passage 312 and the second fluid passage 332 may communicate with each other through a connection fluid passage 342. A fluid supplied through the fluid inlet 311 may be moved to the first fluid passage 312 and at the same time, may be moved to the second fluid passage 332 through the connection fluid passage 342.

The first and second nozzle openings 313 and 333 may be incorporated in the outer cap 34, or may be formed by the combining of a portion where the top surface of the inner cap 32 and the inner top surface of the outer cap 34 meet with the first groove 341.

The camera module 300 according to the present embodiment may include at least one flow rate control unit 340 that implements sequential injection by generating a difference in the flow rate of the fluid injected through the first and second nozzle openings 313 and 333.

The flow rate control unit 340 may include a diameter changing part 344 in which a diameter of at least a section of the first fluid passage 312, the second fluid passage 332, and the connection fluid passage 342 is formed different from a diameter of other sections. For example, a diameter of the second fluid passage 332 may be larger than the diameter of the first fluid passage 312, so that the fluid injection through the second nozzle opening 333 is performed more sequentially than the fluid injection through the first nozzle opening 313, or the diameter of some sections of the connection fluid passage 342 may be larger than other sections to slow the flow rate of the fluid moving to the second fluid passage 332 and the second nozzle opening 333.

The flow rate control unit 340 may include a reservoir 346 for temporarily storing a fluid on the connection fluid passage 342. Since the fluid supplied through the fluid inlet 311 is temporarily stored in the reservoir 346 and then moved to the second fluid passage 332, the fluid injected through the second nozzle opening 333 may be injected onto the surface of the lens 11 sequentially. In this way, even if a fluid is simultaneously supplied to the single fluid inlet 311, the time to reach each nozzle opening 313 and 333 is different, so that sequential injection may be implemented.

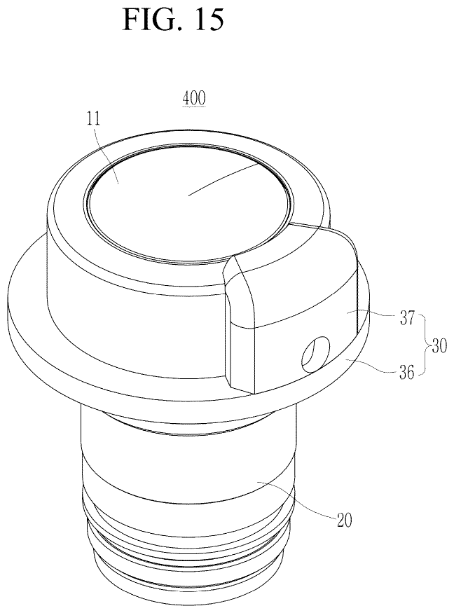

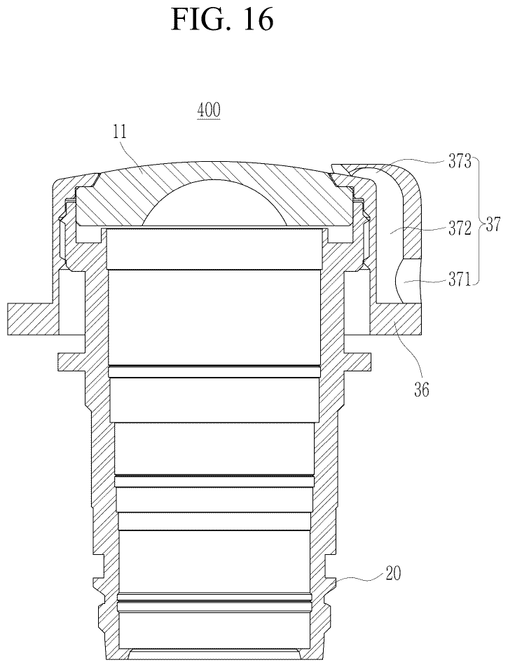

FIG. 15 is a perspective view schematically illustrating a camera module according to another embodiment, and FIG. 16 is a cross-sectional view of the camera module of FIG. 15.

Referring to FIG. 15 and FIG. 16, a camera module 400 according to the present embodiment may be configured such that the lens cap 30 includes a main cap 36 and a channel member 37. The main cap 36 may be disposed at the top of the lens barrel 20 to press-fit and fix the lens 11, and the channel member 37 may serve as a lens cleaning unit by incorporating a fluid injection part.

The channel member 37 may be coupled to a portion of the outer surface of the main cap 36, and a fluid inlet 371, a fluid passage 372, and a nozzle opening 373 may be formed therein. A plurality of the channel members 37 may be disposed at predetermined intervals along the circumference of the lens 11.

The flow passage 372 may be formed by being incorporated into the channel member 37 in a tubular shape, or may be formed by combining the main cap 36 and the channel member 37. In the present embodiment, an embodiment in which the fluid passage may be formed by combining the main cap 36 and the channel member 37 is described. Therefore, a second groove constituting a part of the fluid passage may be formed on the inner surface of the channel member 37, and the fluid passage 372 consisting of the outer surface of the main cap 36 and the second groove may be formed by combining the main cap 36 and the channel member 37.

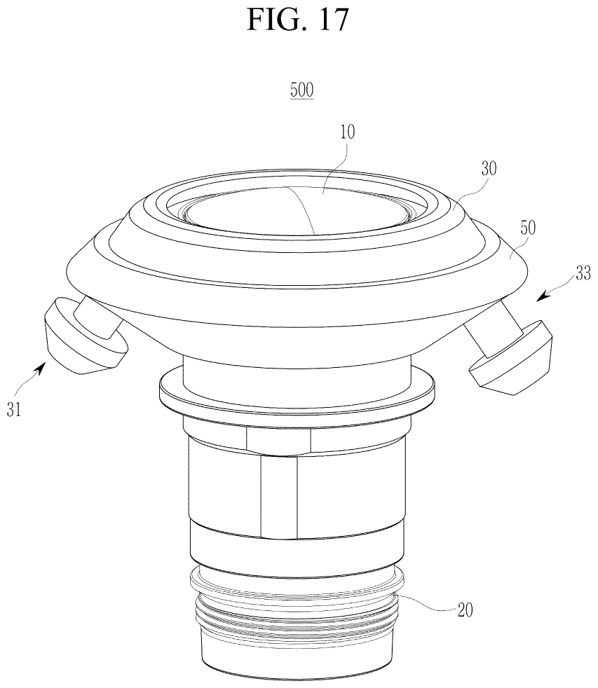

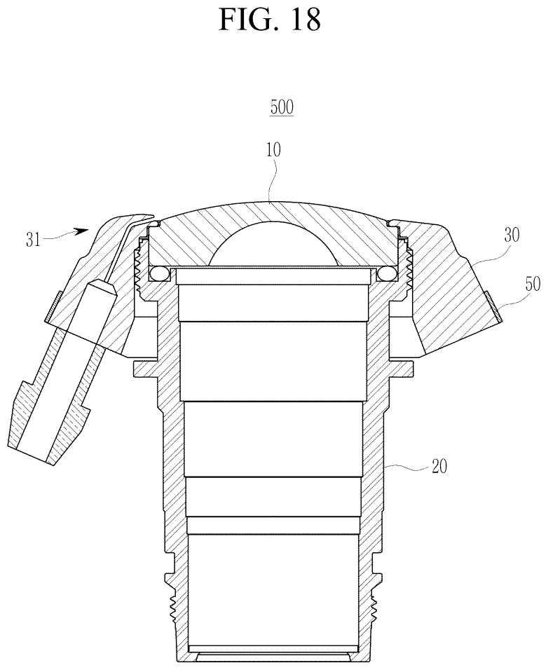

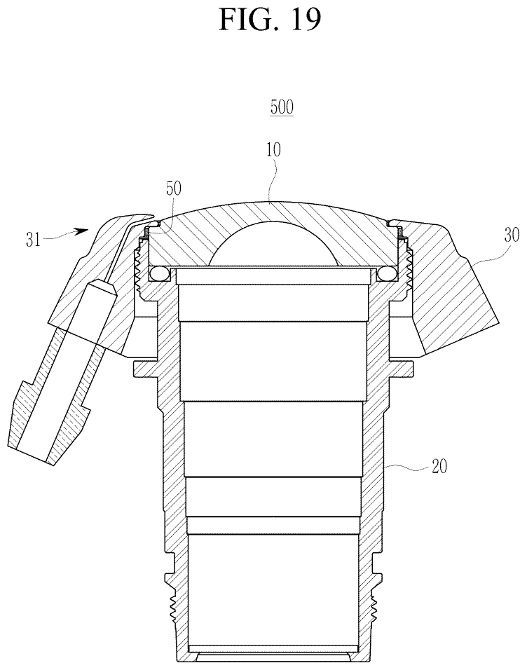

FIG. 17 is a perspective view schematically illustrating a camera module according to another embodiment, FIG. 18 is a cross-sectional view of the camera module of FIG. 17, and FIG. 19 is a cross-sectional view illustrating a modified example of a heating element in the camera module of FIG. 17.

Referring to FIG. 17 to FIG. 19, a camera module 500 according to the present embodiment may include a heating member 50 on at least one of an outer surface and an inner surface of the lens cap 30. Referring to FIG. 17 and FIG. 18, the heating member 50 may be disposed on the outer surface of the lens cap 30, and referring to FIG. 19, the heating member 50 may be disposed on the inner surface of the lens cap 30. The heating member 50 may be, for example, a ring-shaped heating wire or a planar heating film.

The heating member 50 may be disposed in a portion corresponding to at least one of the fluid passage and the nozzle opening formed inside the lens cap 30. The heating member 50 may be entirely disposed around the lens cap 30 or may be disposed only in a portion where the lens cleaning unit is formed.

The heating member 50 heats the lens cap 30 itself to remove frost or condensation on the surface of the lens array 10, while preventing the nozzle opening or the fluid passage from freezing in a low-temperature environment to ensure stable cleaning performance throughout the four seasons.

One aspect of the disclosed embodiment is to provide a camera module that may reduce manufacturing costs by reducing the number of parts and assembly processes by miniaturizing and reducing the weight of the entire module, and increase the degree of freedom in vehicle exterior design.

Furthermore, the present disclosure provides a camera module that ensures high cleaning power with a small amount of cleaning solution and improves operation reliability in low temperature environments.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a lens barrel accommodating a lens;
a lens cap, disposed on a top surface of the lens barrel, configured to press-fit and fix the lens; and
a lens cleaning unit integrally formed with the lens cap and configured to inject fluid to a surface of the lens,
wherein the lens cleaning unit comprises a nozzle opening disposed at a top end of the lens cap and configured to inject fluid toward the surface of the lens, a fluid inlet disposed at a bottom end of the lens cap and configured to receive external fluid, and a fluid passage disposed inside the lens cap and configured to fluidly communicate the fluid inlet with the nozzle opening.

2. The camera module of claim 1, wherein
the nozzle opening comprises a plurality of nozzle openings disposed at predetermined intervals along a circumference of the lens.

3. The camera module of claim 2, wherein
at least one of the plurality of nozzle openings is configured to inject liquid, and at least another one of the plurality of nozzle openings is configured to inject gas.

4. The camera module of claim 2, wherein
at least one of the plurality of nozzle openings is configured to inject cleaning fluid, and at least another one of the plurality of nozzle openings is configured to intake the injected cleaning fluid.

5. The camera module of claim 2, wherein
each of a plurality of fluid passages connected to the plurality of nozzle openings has a different diameter.

6. The camera module of claim 1, wherein
the nozzle opening is continuously disposed along the circumference of the lens.

7. The camera module of claim 1, wherein
the nozzle opening comprises a lower surface portion having a same contour as a contour of the surface of the lens, and an upper surface portion disposed to have a predetermined angle with respect to the lower surface portion.

8. The camera module of claim 7, wherein
the upper surface portion comprises a reflective surface that is configured to change an injection direction of the fluid in the fluid passage to the surface of the lens.

9. The camera module of claim 1, wherein
the lens cap comprises an inner cap disposed at the top surface of the lens barrel to press-fit and fix the lens, and an outer cap coupled along an outer circumferential surface of the inner cap and having the nozzle opening, the fluid passage, and the fluid inlet.

10. The camera module of claim 9, wherein
the outer cap comprises a first groove on an inner surface thereof so that a portion of the fluid passage is formed by coupling with the inner cap.

11. The camera module of claim 9, wherein
the nozzle opening is disposed in plurality at predetermined intervals, and further comprises a plurality of nozzle openings and at least one flow rate control unit configured to generate a difference in flow rate of the fluid injected through the plurality of nozzle openings to implement a sequential injection.

12. The camera module of claim 11, wherein
the flow rate control unit comprises either one or both of a diameter changing part in which a diameter of at least a section of the fluid passage is different from a diameter of other sections of the fluid passage, and a reservoir disposed at the fluid passage and configured to temporarily store fluid.

13. The camera module of claim 1, wherein
the lens cap comprises a main cap coupled to the lens barrel, and a channel member coupled to a portion of an outer surface of the main cap and in which the nozzle opening, the fluid passage, and the fluid inlet are disposed.

14. The camera module of claim 13, wherein
the channel member comprises a second groove on an inner surface thereof so that a portion of the fluid passage is formed by coupling with the main cap.

15. The camera module of claim 1, wherein
either one or both of an outer surface and an inner surface of the lens cap further comprise a heating member disposed at a portion corresponding to the fluid passage.

16. The camera module of claim 1, wherein
the camera module is mounted on an exterior panel of a vehicle, and
an elastic sealing member is further disposed between the top end of the lens cap and the exterior panel to prevent fluid injected from the lens cleaning unit from flowing into the vehicle.

17. A lens cleaning unit, comprising:
a nozzle opening integrally formed on a top end of a lens cap configured to press-fit and fix a lens disposed at a top surface of a lens barrel accommodating the lens, wherein the nozzle opening is configured to inject fluid toward a surface of the lens;
a fluid inlet disposed at a bottom end of the lens cap and configured to receive external fluid; and
a fluid passage disposed inside the lens cap and configured to fluidly communicate the fluid inlet with the nozzle opening.

18. A lens cleaning method using the lens cleaning unit of claim 17, comprising:
supplying fluid from an external fluid source to the fluid passage, and
injecting the fluid toward the surface of the lens through the nozzle opening.

19. The lens cleaning method of claim 18, wherein
the injecting of the fluid comprises sequentially injecting the fluid by varying a flow rate through a plurality of nozzle openings of the nozzle opening formed at the lens cap.

20. The lens cleaning method of claim 18, wherein
the injecting of the fluid comprises injecting liquid through at least one of a plurality of nozzle openings of the nozzle opening and injecting gas through at least another one of the plurality of nozzle openings.
